(19) United States
(12) Patent Application Publication
(10) Pub. No.: US 2010/0223127 A1
(43) Pub. Date: Sep. 2, 2010

(54) Method And Apparatus For Managing Shipping And Advertisement Information In A Communications Environment

(75) Inventors: Jean-Sébastien Bettez, Hudson (CA); Isabelle Bettez, Vaudreuil-sur-le-Lac (CA)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: 8D Technologies Inc., Montreal, QC (CA)

(21) Appl. No.: 12/600,188

(22) PCT Filed: May 14, 2008
(86) PCT No.: PCT/CA2008/000936

§ 371 Date: Nov. 13, 2009

Related U.S. Application Data
(60) Provisional application No. 60/938,109, filed on May 15, 2007.

(51) Int. Cl. G06Q 50/00; G06Q 30/00; G06Q 20/00; G06Q 10/00; G06F 3/048

(52) U.S. Cl. 705/14.51; 705/14.49; 705/17; 705/40; 705/333; 705/341; 715/764

(57) ABSTRACT

A method for receiving a parcel to be shipped to a destination via at least one shipment provider. The method comprises receiving from a sender shipping information associated with the shipment of the parcel to be shipped, the shipping information including destination information and payment information. The method further comprises receiving at a drop-off unit the parcel to be shipped from the sender. The method further comprises associating the shipping information received from the sender with the received parcel. The method still further comprises generating at the drop-off unit a signal to be transmitted to the at least one shipment provider, the signal being indicative that at least one parcel has been received at the drop-off unit.

### FIELD OF THE INVENTION

The present invention relates to the field of parcel shipping, and more specifically to a method and apparatus for managing shipping and advertising in a communications environment.

### BACKGROUND OF THE INVENTION

Drop off boxes for shipment providers are known in the art, and are plagued with numerous deficiencies. For example, on a daily if not more regular basis, the shipment companies are required to pass by the drop off boxes in order to pick up packages contained therein. However, in many circumstances, there are no packages in the drop off boxes, leading to wasted time and effort on the part of the shipment company.

In addition, many payment kiosks, which are used by consumers on a regular basis, are endowed with multimedia interfaces that are not being used to their full potential. Additional lines of revenue could be generated, if better management systems for these payment kiosks were conceived.

In the context of the above, it can be appreciated that there is a need in the industry for a method and apparatus for improving management of drop off boxes and payment kiosks to eliminate inefficiencies and generate new revenues.

### SUMMARY OF THE INVENTION

In accordance with a first broad aspect, the present invention provides a method for receiving a parcel to be shipped to a destination via at least one shipment provider. The method comprises receiving from a sender shipping information associated with the shipment of the parcel to be shipped, the shipping information including destination information and payment information. The method further comprises receiving at a drop-off unit the parcel to be shipped from the sender. The method further comprises associating the shipping information received from the sender with the received parcel. The method still further comprises generating at the drop-off unit a signal to be transmitted to the at least one shipment provider, the signal being indicative that at least one parcel has been received at the drop-off unit.

In accordance with a second broad aspect, the present invention provides a payment kiosk for receiving from a user payment for a good or service. The payment kiosk comprises a common display screen operative for displaying to a user information about the good or service to be purchased and for displaying advertisement information. The payment kiosk further comprises a user interface for enabling a user to enter payment information associated with a good or service to be purchased. The payment kiosk still further comprises a processing unit for generating a signal indicative that a good or service has been purchased by the user on the basis of received payment information. The payment kiosk still further comprises a transmitter suitable for transmitting said signal to a centralized control entity.

These and other aspects and features of the present invention will now become apparent to those of ordinary skill in the art upon review of the following description of specific embodiments of the invention and the accompanying drawings.

### BRIEF DESCRIPTION OF THE DRAWINGS

A detailed description of examples of implementation of the present invention is provided hereinbelow with reference to the following drawings, in which:

FIG. 1 shows a drop-off unit in accordance with a non-limiting embodiment.

FIG. 2 shows an exemplary communicative arrangement with a shipment provider and a plurality of drop-off units.

FIG. 3 shows another perspective of a drop-off unit in accordance with a non-limiting embodiment.

FIG. 4 shows the steps involved in a utilization session of a drop-off unit in accordance with a non-limiting embodiment.

FIG. 5 shows the steps involved between the reception of a parcel and shipping information and the transmission of information to a shipment provider in accordance with a non-limiting embodiment of the present invention.

FIG. 6 shows a system for shipping a parcel in accordance with a non-limiting embodiment.

FIG. 7 shows a payment unit in accordance with a non-limiting embodiment.

FIG. 8 shows another perspective of a payment unit in accordance with a non-limiting embodiment.

FIG. 9 shows an exemplary communicative arrangement with a centralized control entity and a plurality of payment units.

FIG. 10 shows a non-limiting example of contents displayed on the display of a payment unit.

FIG. 11 shows another non-limiting example of contents displayed on the display of a payment unit.

FIG. 12 shows steps involved in a non-limiting example of centralized control entity communication with a payment unit.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

The present invention provides a method and apparatus for managing the shipment of a parcel between an origin and a destination.

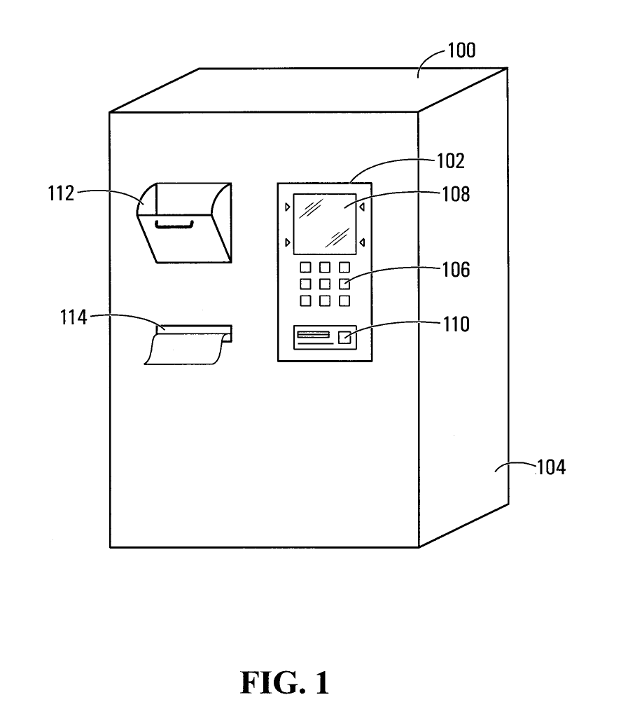

FIG. 1 illustrates a non-limiting embodiment of a parcel drop-off unit 100 in accordance with the present invention. The drop-off unit 100 is suitable for accepting from a sender a parcel to be shipped via a shipping provider, such as FedEx™, Purolator™ or UPS™. Typically, drop-off units, such as the one shown in FIG. 1, are un-maimed devices, designed to be located in publicly accessible locations, so as to provide additional, and more conveniently located regions where a sender can drop-off their parcels to be shipped.

The term sender, as used herein, designates any entity that has a parcel to be shipped to a destination. A sender, can be a business entity or alternatively an individual, among other possibilities.

The term parcel, as used herein, designates any tangible object that can be shipped from an origin to a destination. A parcel, therefore can be a letter, package, box or any other type of object capable of undergoing shipment.

As shown in FIG. 1, the drop-off unit 100 includes a housing 104 defining therein a receptacle (not shown), a receptacle ingress 112, an interface 102 and a printing unit 114. It should be appreciated that the receptacle can have any shape and size suitable for receiving parcels therein. In accordance with a specific, non-limiting embodiment, the receptacle may be tailored to suit the expected use of the drop-off unit 100. For example, in the case where the receptacle is only suitable for receiving letters, the receptacle may be relatively small, whereas in the case where the receptacle is adapted for receiving both letters and larger packages, the receptacle may be a large enclosure, with a padded bottom.

In accordance with a preferred embodiment, the receptacle may be a secure receptacle, such that once one or more parcels have been received by the receptacle, only the shipping provider can retrieve parcels from the receptacle.

As mentioned above, the drop-off unit 100 includes a parcel ingress 112 for receiving a parcel and transferring the parcel to the receptacle. In a non-limiting embodiment, parcel ingress 112 is an opening through which a parcel can be placed into the receptacle. Although only one parcel ingress 112 is shown in FIG. 1, it should be appreciated that multiple parcel ingresses 112 could be included. For example, there may be one parcel ingress 112 for receiving letter-type parcels, and a second parcel ingress 112 for receiving larger package-type parcels 112. In this manner, a user of the drop-off unit 100 would select which parcel ingress 112 to use on the basis of the size of their parcel to be shipped.

In the case where the receptacle is a secure receptacle, as described above, the parcel ingress 112 is a one-way ingress that allows parcels to be inserted into the receptacle but prevents access to the contents of the receptacle, such that parcels cannot be removed from the receptacle through the parcel ingress 112. In yet another embodiment, parcel ingress 112 can be operative for spatially organizing received parcels within the receptacle. For example, the parcel ingress 112 may be operative to organize the parcels inserted into the receptacle, such that they are specially arranged within the receptacle in the order in which they were received.

In the non-limiting embodiment shown, the interface 102 includes a display screen 108, user operable inputs 106 and a payment unit 110. The interface 102 is operative for enabling a sender to receive information from the drop off unit 100, and provide information to the drop-off unit 100.

The display screen 108 is operative for providing information to a user at the drop-off unit 100. For example, the display screen 108 can display instructions, advertisements, or shipping information to a user. It should be appreciated that any other kind of information may be displayed by the display screen 108. In accordance with a non-limiting embodiment, the drop-off unit 100 includes multi-language support, such that any of the instructions, advertisements or shipping information can be supplied to a user in different languages. The choice of language in which to display information may be selected by the user. In addition, although display screen 108 is shown in FIG. 1 as being a standard display monitor, it should be appreciated that any suitable user-viewable output may be used and is included within the intended scope of the present invention.

The user operable inputs 106 are operative for enabling a user to enter shipping information associated with a parcel. Shipping information may be any information related to the shipping of a parcel and may include destination information for the parcel and payment information. It should be appreciated that the destination information can be any information associated with a destination for the parcel. For example, the destination information can be an address of the destination, a code associated with the destination, or any other type of information that conveys to the shipment provider the end destination for the parcel. The shipping information may also include sender information, priority information, urgency information, weight information, parcel dimensions information, parcel contents information, quality of service information, deadline information and time of deposit information, among other possibilities.

In the embodiment shown, the user operable inputs 106 are in the form of buttons. However, it should be appreciated that the user operable inputs 106 can be any suitable inputs for receiving destination information. For example, the user operable input 106 can include a touch sensitive screen, buttons, keypads, voice recognition units, a mouse-like device, or any other input for enabling a user to enter information. User operable input 106 may also include an arrangement of buttons, for example a keyboard for typing in shipment information. In another non-limiting embodiment, user operable input 106 may include a bar code reader, for reading a bar code associated with a parcel.

The payment unit 110 is any suitable device for receiving payment information from the sender. The payment information is any information that provides the shipping provider with the ability to charge the sender, or that provides the shipping provider with information indicative that payment has already been made by the sender. For example, in the case where the payment information is information that provides the shipping provider with the ability to charge the sender, the payment information can be the receipt of coins or bills, credit card information, debit card information, information regarding an account with the shipping provider, etc. . . . Alternatively, in the case where the payment information is information that provides the shipping provider with an indication that payment has already been made, the payment information can be a purchase confirmation code or a bar code or a prepaid card, among other possibilities. It should be appreciated that the payment information is any information regarding a financial transaction or information regarding a past, present or future financial transaction.

Depending on the type of payment information that can be received at the payment unit 110, the payment unit 110 can include a coin or bill receiving device, a credit card reader, a debit card reader, an RFID reader, an infrared port, a Bluetooth™ device and a user operable input, such as those described above. The reader will appreciate that many other techniques for transferring payment information and completing payments are known in the art, all of which are included within the intended scope of the present invention.

Although display screen 108, user operable input 106 and payment unit 110 are shown here as being separate components, it should be appreciated that any two, or all three, may be wholly or partially combined without departing from the scope of the present invention. In a non-limiting example, display screen 108 and user operable input 106 may be combined as a touch screen. In another non-limiting example, user operable input 106 may be combined with display screen 108 for manual input on a touch screen, but may also include a barcode reader for the automated acquisition of both destination information and payment information, thus being also combined with payment unit 110.

The printing unit 114 is optional and may be used to print any information on a suitable medium. In a non-limiting embodiment, printing unit 114 is operative to print a sender receipt on paper. A sender receipt may include any suitable sender receipt information, including waybill, transactional information, shipment tracking information and advertisement. In a non-limiting embodiment, printing unit 114 prints transactional information as well possible advertisement information, as detailed further on in the specification. It should be noted that sender receipt information does not need to be printed on printing unit 114 but may also be displayed on display screen 108 or communicated to the sender by any other suitable means (e-mail, fax, Internet, telephone, etc. . . . ). In another non-limiting embodiment, printing unit 114 is operative for printing a parcel label on sticker-type paper. As such, once the shipping information has been entered by a sender, the printing unit 114 may print a parcel label that contains any required shipping information, such that the parcel label may be affixed to the parcel by a user, thereby associating shipping information with the parcel.

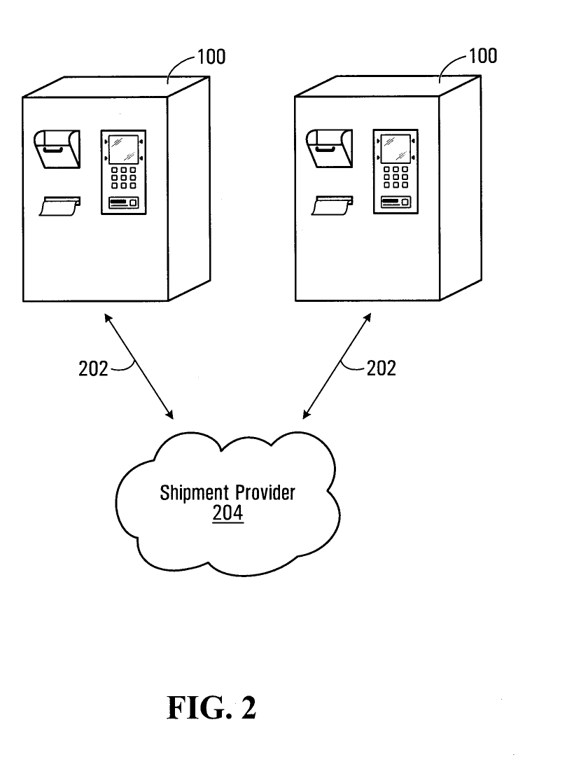

As will be described in more detail below, the drop-off units 100 in accordance with the present invention are operative for being in communication with one or more associated shipment providers, so as to provide the shipment providers with information regarding a received package. As shown in FIG. 2, multiple drop-off units 100 can be in communication with a single shipment provider 204 over respective communication links 202.

The term shipment provider as used herein encompasses any entity that is instrumental in the shipping of a parcel from a sender to a destination. Accordingly, the shipment provider 204 may be a business entity, such as FedEx™, Purolator™ or UPS™. The communication between the drop-off units 100 and the shipment provider 204, may occur between the drop-off units 100 and a central server or other computer implemented control unit at a head office, distribution center or other unit of the shipment provider 204.

The communication between the drop-off units 100 and the shipment provider 204 can be done via a network. The network may include a server that is operative to transmit and receive signals with the drop-off units 100. The server can process and issue signals concurrently using suitable methods known in the computer related arts. The network may include one server or multiple servers such that the drop-off units 100 are interconnected via a server system. The network may be any suitable network, including but not limited to a global public network such as the Internet, a private network, such as an Intranet, or a wireless network, such as a cellular network, or a combination thereof.

Optionally, in a non-limiting embodiment, the shipment provider 204 may also be in communication with a plurality of portable communication devices. Portable communication devices can be any device suitable for receiving information from a shipment provider 204. In a non-limiting embodiment, a portable communication device is a PDA-type wireless device, used by a courier driver, that receives information on a required pickup at a drop-off unit 100. Of course there exist many kinds of portable devices suitable for receiving information from a shipment provider 204 any of which may be used, including: mobile telephones, smart-phones such as Blackberry™-type devices, portable computers (laptops, palmtops, etc. . . . ), radio devices, digital radio devices, and pagers, among other possibilities. It is also to be appreciated that the information received by portable communication device can be any information contained at server 204 and may include information on the status of a drop-off unit 100, maintenance information for a drop-off unit 100, a level of a fullness of a drop-off unit 100, alerts/warnings generated at a drop-off unit 100, information related to parcels contained in a drop-off unit 100 such as the shipment information described above, deadlines or urgencies associated with a drop-off unit 100, and information related to a drop-off unit 100 (time since last pickup, scheduled pickup, type of parcels accepted, etc. . . . ).

It will be appreciated that a portable communication device may be used by any of a number of individuals in relation with the operations of a shipment provider including: drivers, parcel handlers, maintenance crews, managerial staff, consultants, contractors, and repair crews. Communication between shipment provider 204 and a portable communication device may be unidirectional or bi-directional and may be over any suitable medium and may be a direct link or an indirect-link such as a network connection. The communication may be analogue or digital, and may employ any suitable communication standards. In a non-limiting embodiment, the connection includes a wireless portion. In another non-limiting embodiment, the connection uses a packet-switching network such as the Internet. It should be appreciated that circuit-switched and virtual circuit-switched networks also fall within the intended scope of the invention.

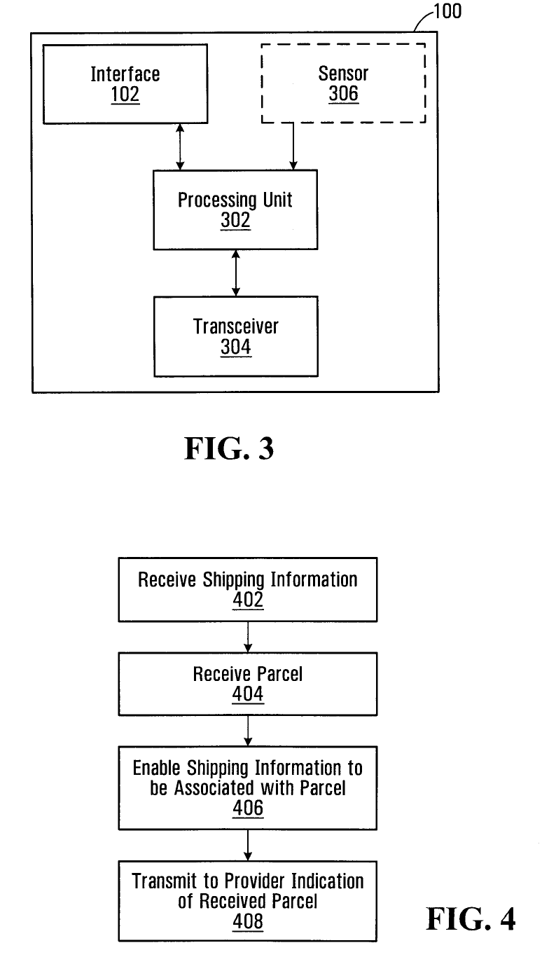

Shown in FIG. 3 is a functional block diagram of the drop-off unit 100. As shown, the drop-off unit 100 includes a processing unit 302, a transceiver 304 and, optionally, a sensor 306. Also illustrated is interface 102, which has already been discussed above.

Sensor 306 is an optional component, and may include any sensor arrangement that is suitable for perceiving certain parameters of the drop-off unit 100 or of the parcels contained therein. For example, sensor 306 can include security breach detectors for detecting a physical intrusion at the drop-off unit 100 or a receptacle fullness sensor that perceives a fullness level of the receptacle on the basis of the weight of the contents of the receptacle. Sensor 306 may also include a weight sensor for determining the weight of individual parcels. This may be done by determining the increase in overall weight of the contents of the receptacle when the parcels are inserted. Sensor 306 may also include sensors for sensing parameters of received parcels, such as a dimension sensor. In accordance with another non-limiting example, sensor 306 includes various functional sensors for detecting drop-off unit functional parameters, such as a low-paper sensor in printer 114, a low-ink sensor in printer 114 or a low battery sensor. It is to be appreciated that sensor 306 can include any number of devices for perceiving any number of parameters.

The processing unit 302 is in communication with interface 102, and optionally the sensor 306, for receiving information entered by a user via the interface 102 and optionally information received from the sensor 306. On the basis of this information, the processing unit 302 is operative for generating a signal indicative that a package has been received at the drop-off unit 100 and for passing this signal to the transceiver 304 such that the signal can be transmitted to the shipment provider 204.

The signal to be transmitted to the shipment provider is any signal indicative that a parcel has been received at drop-off unit 100. It is to be appreciated that the signal to be transmitted may or may not be associated with a single parcel. In a non-limiting embodiment, the signal is transmitted upon the receipt of each parcel within the receptacle and contains a subset of the shipping information received by interface 102. In another, non-limiting example, the signal to be transmitted to the shipment provider may include any of the following: time information (time of day, time since last pick-up, time until a parcel deadline, time since first parcel was received since the last pick-up, etc. . . . ), fullness of the receptacle information, service request information, alert information, status report information advertisement information, usage information, and a request for a transmission (instructions, software update, a repeat transmission, etc. . . . ).

In accordance with a non-limiting embodiment, the processing unit 302 is in communication with a memory unit that stores data and program instructions. The processing unit 302 can have any suitable hardware, software or firmware for processing the data and, optionally, program instructions in order to execute the various functions of the drop-off unit as described herein. Those skilled in the art should appreciate that the program instructions may be written in a number of programming languages for use with many computer architectures or operating systems. For example, some embodiments may be implemented in a procedural programming language (e.g., “C”) or an object oriented programming language (e.g., “C++” or “JAVA”).

Transceiver 304 is any input/output device suitable for exchanging data with the service provider 204 over communication link 202. Transceiver 304 is operative for receiving outgoing data from the processing unit 302 and transferring the outgoing data to the shipment provider 204 over communication link 202. As will be described in more detail below, in a preferred embodiment, the transceiver 304 is also operative for receiving incoming data from shipment provider 204 over communication link 202. Transceiver 304 can include any number of transmitters and receivers for establishing any number of communication links 202 over any number of different media. Although FIG. 3 shows that the drop-off unit 100 includes a transceiver 304 having both transmitting and receiving capabilities, in an alternative embodiment, the drop-off unit 100 may only include a transmitter for transmitting signals to the shipment provider 204. In such an embodiment, the drop-off unit 100 would include unidirectional communication capabilities.

Although FIG. 3 shows the processing unit 302 and the transceiver 304 as being an integral part of the drop-off unit 100, it should be appreciated that in an alternative embodiment, the processing unit 302, the transceiver 304 and, optionally, the interface 102 may not be integrally included within the drop-off unit 100. Instead, these components may be included in a separate entity that can be retro-fit into existing drop-off boxes, such that existing drop-off boxes can acquire the functionality described herein. For example, the interface 102, the processing unit 302 and the transceiver 304 can be contained in a separate housing that is suitable for being associated with an existingdrop-off box, such that the present invention also provides retrofitting possibilities for existing drop-off boxes.

It should be appreciated that the drop-off units 100 in accordance with the present invention can be powered in any suitable manner. For example, the drop-off units 100 can be plugged into an electrical wall socket, they can be powered by one or more batteries, or alternatively, they can be solar powered. In the case where the drop-off units 100 are solar powered, they may include solar panels on the exterior surface of their housing.

Referring back to FIG. 2, the shipment provider 204 is in communication with a plurality of drop-off units 100 and receives therefrom respective signals indicative that at least one parcel has been received at the drop-off unit 100. Shipment provider 204 collects information from the drop-off units 100 and is thus able to coordinate the collection of parcels from drop-off units 100. For example, the receipt of a signal from a drop-off unit 100 can advise the shipment provider 204 that a parcel is waiting to be picked up at the drop-off unit 100. In this manner, the shipment provider 204 can avoid making trips to drop-off units 100 that have not received any parcels, and can also help the shipment provider to avoid long delays between a parcel being received at a drop-off unit 100 and the parcel being picked up at the drop-off unit. In addition, depending on the information contained in the signal transmitted from the drop-off unit 100 to the shipment provider 204, the shipment provider can coordinate the collection of parcels on the basis of any or all of the following: the fullness of the drop-off unit 100, the time of day, the time since the last parcel pick-up and the urgency, shipping deadline or destination of (a) parcel(s) at the drop-off unit 100, among other possibilities.

In addition to being able to receive information from the drop-off units 100, the shipment provider 204 may also be able to send information to the drop-off units 100 over the communication link 202. In other words, communication link 202 may be used by the shipment provider 204 to send any useful information to the drop-off units 100. This information can be software updates, information on shipping service prices, advertisement information or any other information useful to the functions of drop-off units 100. Any information from the shipment provider 204 may be sent to all drop-off units 100 or may be sent to only a single drop-off unit 100, or a select set of drop-off units.

It should be appreciated that communication link 202 can be any suitable connection for establishing communication between the drop-off units 100 and shipment provider 204. Communication link 202 may transport digital or analogue signals and may be wired or wireless. In accordance to a non-limiting embodiment, communication link 202 comprises at least one wireless portion. Communication link 202 may employ a network. In accordance to a non-limiting example, communication link 202 employs a cellular telephony network. In accordance with another non-limiting embodiment, communication link 202 employs a packet-switched network such as the Internet. In accordance to yet another non-limiting embodiment, communication link 202 may employ a circuit-switched or a virtual circuit-switched network. It is to be appreciated that communication link 202 may comprise a combination of the various embodiments described such as an Internet connection running over a wireless telephony network. Furthermore, and as described above, although communication link 202 has been shown here as a bi-directional link, communication link 202 may also be a one-directional link for communications from the drop-off unit 100 to the shipment provider 204. Furthermore, it is to be appreciated that although a single communication link 202 has been illustrated, any number of communication links 202 may connect drop-off units 100 to shipment provider 204.

Although the present embodiment has been illustrated with two drop-off units 100 it should be appreciated that any number of drop-off units 100 may be in communication with the shipment provider 204 without departing from the spirit of the invention. Thus the drop-off units 100 in communication with the shipment provider 204 form a network of 1, 2 or any other number of drop-off units 100.

The steps involved in the normal course of operation of the drop-off unit 100 will now be described in accordance with the non-limiting method illustrated in FIG. 4. At step 402, the drop-off unit receives shipping information from a sender. This shipping information may be provided by the sender when the sender arrives at the drop-off unit 100 with a parcel to be shipped, or alternatively, this information may have been previously entered by the sender at a remote location.

In the case where the user provides the shipping information at the drop-off unit 100, the sender may enter the information via the user operable inputs 106 in response to instructions provided by the display screen 108 or elsewhere on the drop-off unit 100. As mentioned above, the shipping information may include the weight and dimensions of the parcel, the destination, the type of contents, and a quality of service required, among other possibilities.

In the case where the user has provided the shipping information at a remote location, it is possible that the sender may enter the shipment information via a website at a remote computer For example, and as will be described in more detail further on in the specification, the sender may enter the shipment information over the internet via a website. This could be done at a remote computer that is located at their work premises, or residential premises, among other possibilities. In this embodiment, the sender may enter the shipping information (including the destination information and payment information) into the shipping provider's website, and then submit this information over the internet. Once the shipping information has been submitted to the shipping provider, the sender would then receive a confirmation number, or a printed out bar-code, among other possibilities.

The shipping information provided by the sender includes payment information. As mentioned above, this can be done using a credit card, an account number or the user could have provided cash to a cash-accepting device at the drop-off device such as a coin drop or a bill scanner. It should be appreciated that the user could complete payment or provide payment information in any of a number ways that are known in the art, all of which are intended to fall within the scope of the present invention.

At step 404, the sender inserts the parcel into the receptacle via the receptacle ingress 112. The receipt of the parcel is done following the user having entered the shipping information (including the destination information and payment information) at the drop-off unit 100, or following the user entering information indicative that the shipping information has already been provided at a remote location. For example, in the case where the user has entered the shipping information at a remote computer via a website, the sender could provide the drop-off unit 100 with a confirmation number, or a bar code, such that the drop-off unit 100 knows that the shipping information has been previously received.

At step 406, the parcel is then associated with the received shipping information. In accordance with a non-limiting embodiment, the association may be made externally from the drop-off unit 100, such as by fastening an adhesive label printed from the printing unit 114 bearing the shipping information to the surface of the parcel. In an alternative embodiment, the processing unit associated the shipping information to the parcel on the basis of the order of parcels received in the drop-off unit 100 (i.e. the relative position of the parcel within the receptacle). There exist many other ways of associating a parcel with the shipping information entered at sender, all of which are intended to fall within the scope of the present invention.

In a non-limiting example, the printer 114 prints out a sender receipt for the sender.

At step 408, the drop-off unit 100 communicates to the shipment provider 204 an indication that a parcel has been received.

It is to be appreciated that steps 402, 404, 408 and 410 must not necessarily be performed in the order provided in FIG. 4. Furthermore, certain steps may occur simultaneously. For example a user may first deposit a parcel and only then enter shipping information. Alternatively, a user may enter shipping information, fasten an adhesive label bearing the shipping information and printed by printer 114 to the parcel, thus associating the shipping information to the parcel and only then insert the parcel into the receptacle. Furthermore, information indicative of receipt of the parcel may be transmitted at any time throughout this process, including while other steps are being performed. In a non-limiting example, shipment information may be transmitted to shipment provider 204 as soon as the information is received, or as soon as payment is complete. Payment information may be transmitted while the parcel is being inserted or while shipping information is being received.

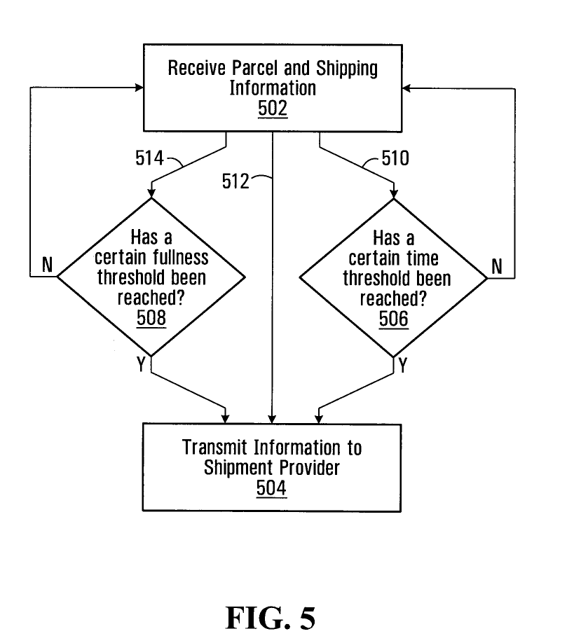

Communication from the drop-of box 100 to the shipping provider 204 may occur on the basis of different criteria, as illustrated in greater detail in FIG. 5. In accordance with a non-limiting embodiment, and as illustrated by arrow 512, drop-off unit 100 communicates with shipment provider 204 every time a parcel is received. Drop-off unit 100 may send any of the shipping information received at user operable interface 106 and payment interface 110, and any additional information determined by drop-off unit 100 such as the weight of the parcel, as soon as the parcel is received.

In accordance with another non-limiting embodiment illustrated by arrow 514, drop-off unit 100 only transmits information indicative of a received parcel when the receptacle has reached a certain fullness threshold. Receptacle fullness may be sensed by sensor 306 or computed by processing unit 302. In a non-limiting example, drop-off unit 100 may only communicate with the shipment provider 204 when the receptacle is 80% full.

In accordance with another non-limiting embodiment illustrated by arrow 510, drop-off unit 100 transmits information indicative of a received parcel after a certain time threshold has been reach. The time threshold can be any time-related threshold and may be any of: a time determined by a deadline for the deliver of one of the parcels in the receptacle, a time since last pick-up has been performed, a time since the first parcel was deposited since last pick-up, a time since a last communication with the shipment provider, or any other time-related limit.

It will be readily apparent that many other conditions may be used to determine when to transmit a communication to shipment provider 204, all of which are included within the intended scope of the present invention. Furthermore, although each condition is provided here in a separate branch, it is to be appreciated that multiple conditions can be combined into a single branch. For example drop-off unit 100 could transmit when either a certain fullness threshold has been reached or a certain time threshold has been reached.

It will be appreciated that drop-off unit 100 may communicate with shipment provider 204 a variety of information other then information indicative of the receipt of a parcel. This information may be exchanged alongside information indicative of the receipt of a parcel or alone. For example drop-off unit 100 may send an alert to shipment provider 204 when a sensor detects an illegal intrusion into the receptacle. Alternatively, drop-off unit 100 may send a message indicative of a status of the unit, such as a low-level of printer paper or of ink. The drop-off unit may also send a message indicative of a failure or other maintenance-related information. The information sent from a drop-off unit 100 to a shipment provider 204 may be used for any of a number of purposes including scheduling pickups (as described above), scheduling/managing maintenance of drop-off units 100, compiling statistics, and company management. Drop-off unit 100 may also receive any information from shipment provider 204 at any time, such as information indicative of a change in shipment rates or information regarding advertisements to display.

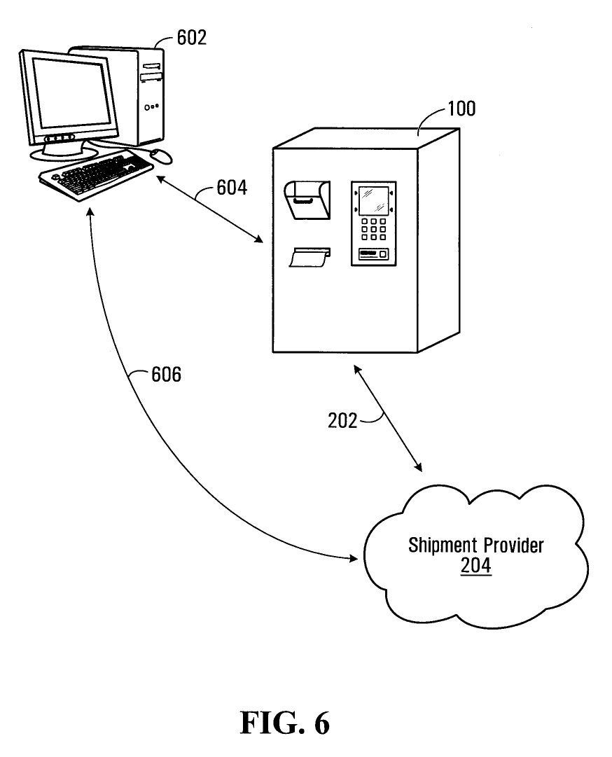

FIG. 6 illustrates a non-limiting embodiment where at least some portion of the steps described in relation with FIG. 4 are performed by a user at home, on an interface 602 such as a computer. Interface 602 is in communication with shipment provider 204 by any suitable communication link 606 such as an Internet connection. In this embodiment, step 402 of providing shipment information, is done by a user on a web interface provided by the shipment provider 204 over the Internet. Optionally, the user also performs the payment over the Internet, such as by a secure credit-card payment, by an internet banking transaction, by a service such as Paypal™ or by using an account the sender has with the shipment provider. Optionally, the user may then print a sender receipt. Optionally, the user may also print an adhesive label on adhesive paper and fasten it to the parcel.

Once the user has completed these steps on interface 602, the user then travels with the parcel to the drop-off unit 100 as indicated by arrow 604. There, the user performs what steps were not performed at interface 606 and inserts the parcel into the receptacle via the parcel ingress 112.

It will again be appreciated that the aforementioned steps need not be performed in the order provided, but that any ordering of these steps is in the intended scope of the invention.

The present invention further provides a method and system for managing advertising capabilities at a payment kiosk.

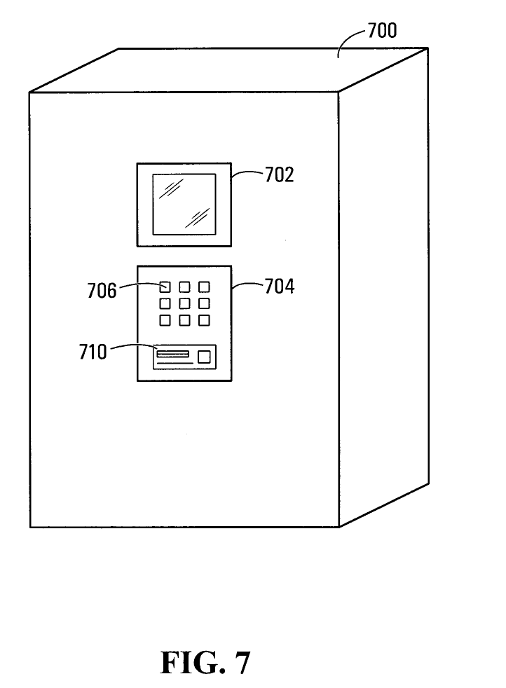

FIG. 7 illustrates a non-limiting embodiment of a payment kiosk 700 in accordance with the present invention. The payment kiosk 700 is any physical station at which a user can pay for a desired good or service. As used herein, the term “good or service” refers to anything that has a value. For example, the good or service purchased at the payment kiosk 700 can be the permission to park in a public parking space, the purchase of a product from a vending machine, or the shipment of a parcel in accordance with the embodiments described above with respect to FIGS. 1-6.

It should be appreciated that the good or service does not need to be tangible or persistent, and can include the rental of something tangible or non-tangible. The goods or services that can be purchased at payment kiosk 700 may change over time or may remain generally unchanging. Furthermore, goods or services purchased at the kiosk 700 may or may not exist at the payment kiosk 700 itself, such as in the case where the service purchased is the temporary permission to park in a public parking spot. Thus a payment kiosk 700 may accept payment for a good or service available remotely from the kiosk. Furthermore, the term good or service as used herein can designate any number of things that collectively or individually have value. Thus a good or service may in fact include a plurality of valuable tangibles or intangibles or may include tangibles in combination with intangibles, such as in the case of a telephone card for use in conjunction with a telephone service.

In accordance with the present invention, the payment kiosk 700 may be spatially fixed or moveable. The payment kiosk 700 may also be suitable for outdoor use. Although payment kiosk 700 is shown here as being a stand-alone kiosk, it is to be appreciated that payment kiosk 700 can be of any suitable shape, size or form, without departing from the spirit of the invention. For example, the payment kiosk 700 may be integrated into a wall or other building component.

As shown in FIG. 7, the payment kiosk 700 includes a display 702 and a user interface 704. As will be described in more detail below, the user interface 704 is operative for enabling a user to enter information for purchasing a good or service from the kiosk 700 and the display 702 is operative for displaying both information relating to a good or service to be purchased as well as advertisement information. As such, the information about the good or service to be purchased as well as the advertisement information is presented on a common display.

Although the common display 702 is shown here as being a flat screen, it is to be appreciated that any suitable user-viewable output may be used as the display 702. The common display 702 may therefore be an CRT screen, a plasma screen, an LED screen and a projection screen, among other possibilities. It should also be appreciated that in addition to the display 702, the kiosk may further include an audio speaker, a printer and a haptics device, among other possibilities.

The information that is displayed via the common display 702 may be any suitable information. For example, the information relating to the good or service to be purchased can include price information on the good or service to be purchased, instructions on how to purchase the good or service, the name of the good or service, a code associated with the good or service, an availability of the good or service, the location of the good or service, among other possibilities. In accordance with a non-limiting embodiment, the payment kiosk 100 includes multi-language support, such that any of the information, advertisements or anything else displayed on the display 702 can be supplied to a user in different languages. The choice of language in which to display information may be selected by the user.

In addition, the advertisement information can be any suitable type of advertisement information. Moreover, the advertisement information can be any information related to the promotion of anything. In accordance with a non-limiting embodiment, the advertisement information may be related to a good or service that can be paid for at payment kiosk 700. In such an embodiment, the advertisement information and the information related to the good or service to be purchased may be wholly or partially combined together. In accordance with a further non-limiting example, the advertising information can be related to a good or service that is completely unrelated to the good or service being purchased at payment kiosk 700. For example, advertisement information may be any type of still image or video advertisement relating to the promotion of any good or service, such as advertisements for makeup, cars, watches, spa treatments, hotels, etc. . . . Alternatively, the advertisement information can be any type of promotional material relating to a charitable organization, a political campaign, public education/awareness on any particular issue. For example, the advertisement information can include information regarding upcoming events, sales/promotions information, television/radio programming information, shopping information, local attractions, etc. . . .

As will be discussed further on, advertisement information may also be related to information received from a user at the user interface 704. In this manner, the advertisement information displayed may be tailored based on input information received at the user interface 704.

In an optional embodiment, the common display may also display what can be considered useful information to a user. Useful information can be any information that may be of interest to at least a subset of users of the payment kiosk 700. For example, the useful information may include any of the following: news information, weather information, security information, lottery information, map/location information, sports information, a level of alert, recommended precautions, zoning information, tourist interests, historical information, encyclopedic information, traffic information, stock/investment information, survey information, and anticipated service disruptions information. It is to be appreciated that useful information may be stand-alone or may be related to advertisement information or to information related to good or service to be purchased. Useful information may therefore be wholly or partially combined with advertisement information or with information relating to goods or services to be purchased. Useful information displayed may also be related to information received from a user at user interface 704.

The advertisement information can be displayed on the display 702 in a variety of different manners. For example, the advertisement information may be displayed via still images that are periodically displayed at one or more regions of the screen. Alternatively, the advertisement information could be continuously running in a dedicated section of the screen either via still images or videos. Or, in yet a further embodiment, the advertisement information could be provided in text form that scrolls across a portion of the display screen.

As mentioned above, in addition to the display screen 702, the payment kiosk 700 further includes an interface 704 for enabling a user to purchase a good or service from the kiosk 700. In the non-limiting embodiment shown in FIG. 1, the interface 704 includes a user operable input 706 for accepting from a user information related to a good or service to be purchased, and a payment unit 710 for accepting from a user payment information.

In the embodiment shown, the user operable inputs 706 are in the form of buttons. However, it should be appreciated that the user operable inputs 706 can be any suitable form of inputs for receiving information from a user. For example, the user operable input 706 can include a touch sensitive screen, buttons, keypads, voice recognition units, a mouse-like device, or any other input for enabling a user to enter information. In another non-limiting embodiment, user operable input 706 may include a bar code reader, for reading a bar code associated with a good or service.

In accordance with the present invention, the user enters information associated with the good or service to be purchased via the user operable input 706. This information may be entered in response to instructions and/or prompts displayed on the display 702. In the case where the kiosk 700 is a parking kiosk for receiving payment for parking in a public parking space, the information entered by the user can include a desired parking space and a quantity of time for which to rent the space.

It should be appreciated that depending on the nature of the payment kiosk 700, the type of information entered by a user may vary. In most cases, the user will provide an indication of the good or service to be purchased. The good or service may be identified directly, such as via the name of the good or service desired. Or the information may identify the good or service indirectly, such as via an identification code associated with the good or service desired or by features of a good or service desired.

It is also to be appreciated that information entered by the user may further include information indicative of parameters associated with the good or service desired. For example, the user may enter certain parameters associated with the good or service desired, such as a length of time or a delay, a quantity, a color, optional features or services, physical features such as shape or size, a desired warrantee and a quality level. It will be evident to one skilled in the art that any other information may be entered by a user at the user operable input 706 in addition to information related to a good or service to be purchased. Additional information may include personal information such as identification/contact information, information indicative of desired useful information such as a request for any particular useful information described above, survey information, customer feedback information, advertisement-related information such as an indicator of interest for a displayed advertisement, a request for help and a request for servicing of the payment kiosk 700.

It will further be appreciated that although the present embodiment includes a user operable input for accepting information related to a good or service to be purchased, a payment kiosk 700 may be devoid of a user operable input 706 without leaving the intended scope of the present invention. In a specific, non-limiting example, user operable input 706 may not be necessary if no information on a good or service to be purchase is needed. For example, if only one good or service is available at the kiosk 700, or if payment information received at payment unit 710 is indication enough of the good or service to be purchased, then it may not be necessary for a user to enter information associated with the good or service to be purchased. In such a situation, the user may simply provide the appropriate payment for the good or service being sold at the kiosk.

As such, the interface 704 includes the payment unit 710. The payment unit 710 is any suitable device for receiving payment information from the user. The payment information is any information that allows the user to be charged for a good or service that is being purchased, or that provides the kiosk 700 with information indicative that payment has already been made by the user. For example, in the case where the payment information is information that allows the user to be charged for a good or service, the payment information can be credit card information, debit card information, information regarding an account with the provider of the good or service, etc. . . . The payment information could also be the exchange of coins or bills with the kiosk 700.

Alternatively, in the case where the payment information is information that provides the kiosk with an indication that payment has already been made, the payment information can be a purchase confirmation code, a bar code or a prepaid card number, among other possibilities. It should be appreciated that the payment information is any information regarding a financial transaction or information regarding a past, present or future financial transaction.

Depending on the type of payment information that can be received at the payment unit 710, the payment unit 710 can include a coin or bill acceptor, a credit card reader, a debit card reader, an RFID reader, an infrared port, a Bluetooth™ device and a user operable input, such as those described above. The reader will appreciate that many other techniques of transferring payment information and completing payments are known in the art, all of which are included within the intended scope of the present invention.

Although common display 702, user operable input 706 and payment unit 710 are shown here as being separate components, it should be appreciated that any two, or all three, may be wholly or partially combined without departing from the scope of the present invention. In a non-limiting example, common display 702 and user operable input 706 may be combined as a touch sensitive screen. In another non-limiting example, user operable input 706 may be combined with the payment unit 210, such that the user can enter a credit card number, or account number via the user operable input 706.

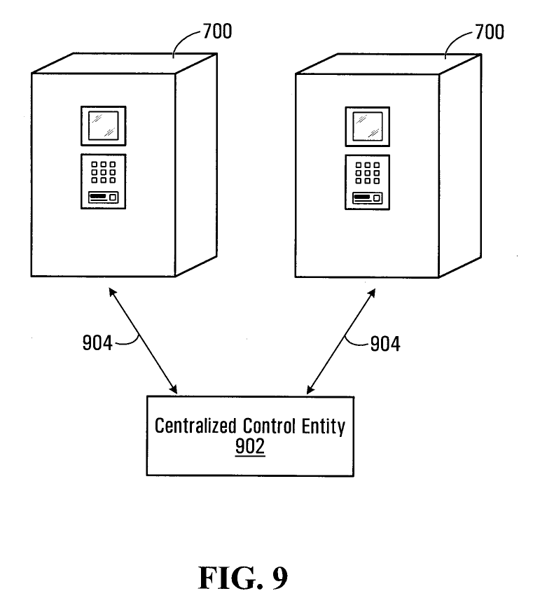

As shown in FIG. 9 and as will be described in more detail throughout, one or more of the payment kiosks 700, as described above, are operative for being in communication with a centralized control entity 902, so as to be able to exchange information with the centralized control entity 902. As shown in FIG. 9, the multiple payment kiosks 700 are in communication with a single centralized control entity 902 over respective communication links 904.

The term centralized control entity 904 as used herein encompasses any entity that is operative for managing a network of payment kiosks 700. Accordingly, the centralized control entity 904 may be a business entity, such as a courier service company or a parking service provider. The communication between the payment kiosks 700 and the centralized control entity 904, may occur between the payment kiosks 700 and a central server or other computer implemented control unit at a head office, business center or other unit of the centralized control entity.

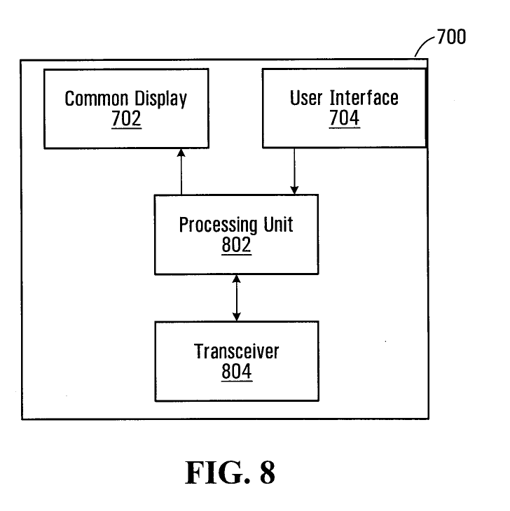

Shown in FIG. 8 is a functional block diagram of the payment kiosk 700. As shown, the payment kiosk 700 includes a processing unit 802, a transceiver 804, common display 702 and a user interface 704, which have been described above.

Payment kiosk 700 may include a sensor (not shown) that is an optional component, and may include any sensor arrangement that is suitable for perceiving certain parameters of the payment kiosk 700. For example, the sensor can include security breach detectors for detecting a physical intrusion at the payment kiosk 700. In accordance with another non-limiting example, the sensor includes various functional sensors for detecting payment kiosk functional parameters, such as a low battery sensor. It is to be appreciated that the sensor can include any number of devices for perceiving any number of parameters.

The processing unit 802 is in communication with the user interface 704 for receiving information entered by a user via the user interface 704. On the basis of this information, the processing unit 802 is operative for generating a signal indicative that good or service has been purchased at the payment kiosk 700 and for passing this signal to the transceiver 804 such that the signal can be transmitted to the centralized control entity 902.

In accordance with a non-limiting embodiment, the processing unit 802 is in communication with a memory unit that stores data and program instructions. On the basis of this data and program instructions, the processing unit is operative for controlling at least in part, the functionality of the common display 702 and the interface 704 (i.e. controls the content to be displayed on the display screen, controls the functionality of the payment unit 710, etc. . . . )

As mentioned above, payment kiosk 700 is operative for transmitting to the centralized control entity 902 information indicative that a good or service has been purchased. In a non-limiting embodiment, processing unit 802 processes information received at user operable input 708 indicating a desired good or service, determines an availability of the good or service, processes payment information received at payment unit 710 and causes transmitter 804 to transmit to centralized control entity 902 information indicative of the good or service purchased and of the payment information received. In another non-limiting embodiment, payment kiosk 700 receives information indicative of a good or service to be purchased, transmits information associated with a good or service to be purchased to centralized control entity 902, receives from centralized control entity an availability of the good or service, receives payment information from payment unit 710, transmits payment information to centralized control entity 902 and receives information indicative of a success of the transaction.

Transceiver 804 is any input/output device suitable for exchanging data with the centralized control entity 902 over communication link 904. Transceiver 804 is operative for receiving incoming data from centralized control entity 902 over communication link 904. As will be described in more detail below, in a preferred embodiment, the transceiver 804 is also operative for transmitting information from the payment kiosk 700 to the centralized control entity 902 over communication link 904. Transceiver 804 can include any number of transmitters and receivers for establishing any number of communication links 904 over any number of different media. Although FIG. 8 shows that the payment kiosk 700 includes a transceiver 804 having both transmitting and receiving capabilities, in an alternative embodiment, the payment kiosk 700 may only include a receiver for receiving signals from the centralized control entity 902. In such a case, the kiosk would not transmit information to the centralized control entity 902, and would only receive information from the centralized control entity 902 such that the payment kiosk 700 would include only unidirectional communication capabilities.

In accordance with the present invention, the advertisement information to be displayed by display 702 is forwarded to the payment kiosk 700 from the centralized control entity 902. The advertisement information that is transmitted to the payment kiosks 700 from the centralized control entity 902 may also be sent with data indicative of the manner in which the advertisement information should be displayed. For example, in addition to the actual advertisement information, the centralized control entity may provide each kiosk 700 with information regarding when and how to display the advertisement information. For example, the information may provide instructions on the frequency of display (i.e. show advertisement every 10 seconds), the manner in which the advertisement is displayed (i.e., display in a certain area of the display screen 702, display in the background of the screen, etc. . . . ) as well as the ratio of which advertisements to show more frequently (show the Rolex advertisement 3 times per minute, and the Chanel advertisement 1 time per minute, or show the Rolex advertisement to only 20% of users of the kiosk) etc. . . . In another non-limiting embodiment, the information regarding when and how to display the advertisement information can be based on any suitable conditions and criteria. For example, the manner in which the advertisement information can be displayed can be tailored on the basis of a variety of factors including: a time condition such as a time of day range, a specific user input such as a specific good or service desired, a method of payment, user profile information, the location of the payment kiosk 700, the historical use of payment kiosk 700 (such as a level of business of payment kiosk 700) and a popular good or service at payment kiosk 700, among other possibilities.

In accordance with a non-limiting embodiment, centralized control entity 902 is operative for controlling display parameters of advertisement information at the payment kiosk 700. Display parameters are any parameters associate with the display of advertisement information at a payment kiosk 700 and may include the frequency of displaying an advertisement (i.e. once every 10 second), the length of time for which to display an advertisement (i.e. for 2 second intervals), a specific instruction to display an advertisement (i.e. only when a user is at the kiosk), conditions for the display of an advertisement (i.e. only between 9 am-5 pm) and a period of time in which to display an advertisement (i.e. for a 3 week period). Conditions can be any suitable condition and may be based on: a user profile as determined by user input or payment information, a type of good or service to be purchased, a location of a payment unit 700 or of a good or service to be purchased, or any other location, a time of day, a past, current or upcoming event, a security status, a weather condition and an economic condition, among other possibilities.

In addition to advertisement information, the centralized control entity 902 can also provide the payment kiosk 700 with information relating to the good or service that can be purchased at the kiosk. In a non-limiting embodiment, the centralized control entity 902 can provide one or more of the kiosks 700 with which it is in communication, with any of the following information: a price for a good or service, an availability of a good or service, updated information on a good or service, instructions for use or purchase of a good or service, a request for information related to a good or service such as a request for sales data, and instructions to payment kiosk 700 related to a good or service.

It should be appreciated that both the information relating to a good or service offered at the kiosk 700, as well as the advertisement information, can be received from centralized control entity 902 separately or wholly or partially combined. For example, the information about the goods or services to be offered includes advertisement information for those goods or services. As such, the display 702 is caused to display information relating to the good or service alongside promotional/advertisement information relating to that good or service.

In the case where the payment kiosk 700 is able to display, via display 702, useful information such as weather information, that useful information is also transmitted to the payment kiosk 700 from the centralized control entity 902. Although information related to useful information is described here separately form advertisement information and from information related to a good or service to be offered, the useful information may be wholly or partially combined with both of these two other informations. For example, the advertisement information may be displayed along with the useful information, so as to attract the attention of a user to the advertisement information.

In addition to the above, payment kiosk 700 may optionally receive control information from centralized control entity 902. Control information is any information that provides instructions to payment kiosk 700. In a non limiting embodiment, control information received from centralized control entity 902 includes any of the following: software updates, a request for a transmission/retransmission, a request to execute a certain code or procedure, an on/off order, synchronization information, a request to enter a certain mode of operation and a request for a report such as a status report or a usage report. The reader will appreciate that many other kinds of control information may be received at payment kiosk 700 from the centralized control entity 902, all of which are in the intended scope of the present invention. The control information may be sent separately, or in combination with any of the information about a good or service, the advertisement information or the information about useful information.

Each kiosk 700 may be operative for displaying multiple different advertisements. In such an example, each one of the different advertisements to be displayed by the kiosk is associated with a different priority level. For example, some advertisements may be provided with a high priority level, which others are associated with a medium and low priority level. In such a case, the centralized control entity 902 may transmit to payment kiosks 700 instructions to display high priority adds 50% of the time, medium priority adds 30% of the time and low priority adds 20% of the time.

In another non-limiting embodiment, the different advertisements provided to the payment kiosk can be categorized in a variety of ways, such that the instructions for displaying the advertisements are based on their categorization. For example, a first category defines advertisement content that is always suitable for display and that should be displayed to 50% or more of all users. A second category defines advertisement content for luxury items preferably displayed to users paying with gold or platinum credit cards. As such, this second category of advertisement content is displayed over other advertisement when a user matches this profile. A third category defines advertisement content promoting cool beverages, such that this content is displayed over other advertisements when weather conditions are hot and sunny. It is to be appreciated that a category can be further divided into sub categories such that multiple conditions may be imposed on advertisement content.

In a non-limiting example, two broad categories define advertisement content to be displayed when no user is using payment kiosk 700 and advertisement content to be displayed to a user currently using payment kiosk 700. In this non-limiting example, the first broad category is sub-divided into the first set of three categories described above (priority levels) and the second broad category is subdivided into the second set of three categories described above (the conditional display). It is to be appreciated that categories may not be mutually exclusive but that certain advertisement information may belong to plural categories. Furthermore, although categories have been described here as defining a priority level or condition for advertisement information, any suitable criterion may be used for dividing advertisement information into categories.

The decision of which advertisement information to display to a user may be done on the basis of program instructions included within the processing unit 802 of the payment kiosk 700. Alternatively, the control of the advertisement information to display at the kiosk may be done at the centralized control entity 902 on a user-by-user basis for some or all payment kiosks 700.

It should be clear from the foregoing that centralized control entity 902 may be instrumental in the coordination of the display of advertisement information at the payment kiosks 700. In a non-limiting embodiment of the present invention, centralized control entity 902 receives information related to usage of payment kiosk 700 in real-time and sends real-time instructions to payment kiosk 700 to display specific advertisement information. It is to be appreciated, however, that control of the display of advertisement information needs not be entirely centralized and that the decision of what specific advertisement information to display at any given time or place may be taken at the central control entity 902, the payment kiosk 700 or anywhere else.

Although centralized control entity 902 is illustrated here as a separate entity, it should be appreciated that centralized control entity may take the form of a distributed entity operating over some or all payment kiosks 700. In another non-limiting embodiment, payment kiosk 700 may receive from centralized control advertisement information defining advertisement content to display on display 702 as well as instructions for the display of advertisement content. Such instructions may include categories as described above and instructions on how to treat each category. In this non-limiting example, a payment kiosk 700 may then independently decide what advertisement content to display on the screen, wholly or partially on the basis of the instructions received from centralized control 902.

In accordance with a non-limiting example, the payment unit 700 can send to centralized control entity 902 advertisement reports indicative of the advertisement content that has been displayed on display 702. Advertisement report may include a number of times an advertisement has been displayed, a total duration of time an advertisement has been displayed, a number of times preferred conditions for an advertisement have been met and a number of times an advertisement has been displayed under its preferred conditions. Optionally, in this embodiment, centralized control entity 902 may direct a payment kiosk 700 to alter the way it displays advertisement information, for example by sending payment kiosk 700 new advertisement information and new instructions for the display of advertisement content, on the basis of an advertisement report received at centralized control entity 902. It is to be noted that a directed change for a payment kiosk 700 must not necessarily be the result of an advertisement report sent by the same payment kiosk 700 but may be the result of an advertisement report of any payment kiosk 700 in communication with central control entity 902.

Every payment kiosk 700 may receive the same advertising information from centralized control entity 902, or alternatively different payment kiosks 700 may receive different advertisement information. In a non-limiting embodiment, the advertisement information sent to the payment kiosk 700 is determined on the basis of any of the following: location of the kiosk, types of goods or services available at the kiosk, historical or predicted use of the kiosk, typical profile of user of the kiosk, proximity of the kiosk to a point of interest or to an advertised good or service and past or current advertisement content displayed by the kiosk. In another non-limiting embodiment, all advertisement content is sent to all payment kiosks 700 in communication with central control entity 902 and payment kiosks 700 are operative to determining locally which advertisement content they are intended to display or which advertisement content they will display.

The manner in which an advertiser is charged for the advertisement services offered by the payment kiosk 700 and the centralized control entity 902 can be done in a variety of different ways. For example, the advertiser can be charged a flat fee for the privilege of having their advertisement displayed on the kiosks 700. Alternatively, the advertiser can be provided with a fee structure depending on the number of times their advertisement is displayed. For example, there may be a base package in which their advertisement is displayed x time per day, and a more expensive package in which their advertisement is displayed 2x times per day.

Alternatively, the advertiser may be charged depending on the advertisement report that is received from each kiosk 700. For example, the centralized control entity may determine a fee based on the number of times an advertisement has been displayed on one or more kiosks, as reported by the kiosks in their advertisement reports. In another non-limiting example, the fee may be determined on the instances of display of advertisement content with different instances being weighed differently. For example, there could be an increased charge for advertisements that are displayed between 9 am and 5 pm. Any suitable basis for determining the weight of an instance of display may be used, including: the conditions under which the content was displayed (was it displayed under the preferred conditions), the payment kiosk 700 at which the content was displayed (centrally located or highly busy kiosks may be higher valued), the time of day in which it was displayed, the user profile to which the content was displayed and the good or service that was purchased by the user to whom the content was displayed. Instances of display of advertisement content may be directly measured, for example read in advertisement reports, or may be inferred from the instructions sent to the payment kiosks 700 and usage of the payment kiosks 700. In a non-limiting example, centralized control unit 902 infers the number of instances of displayed advertisement at a payment kiosk 700 from the number of users having used payment kiosk 700 and the probability of displaying the advertisement to each user.

The reader will appreciate that there exists many different ways to charge for advertisement services, all of which are in the intended scope of the present invention. Alternatively, in a non-limiting embodiment, calculation of fees may include determining an amount of time for which advertisement content was displayed. This may be particularly useful when advertisement content is to be displayed on a payment kiosk 700 when not being used for a specific purchase. It is to be appreciated that any suitable criterion can be used to determine a fee for advertisement services, including any of the following: a level of public exposure to the content, time period during which the advertisement content was available or displayed, location where the advertisement content was made available or displayed, conditions in which the advertisement content was available or displayed, overall usage of the payment kiosks 700, and other advertisement campaigns related to the content. In a non-limiting embodiment, a fee is determined prior to the display of content on payment kiosks 700 on the basis of an expected public exposure to the advertisement content. Optionally, in this embodiment, the fee may be corrected or recalculated at any point after content is displayed on payment kiosks 700 on the basis of actual public exposure to the advertisement content.

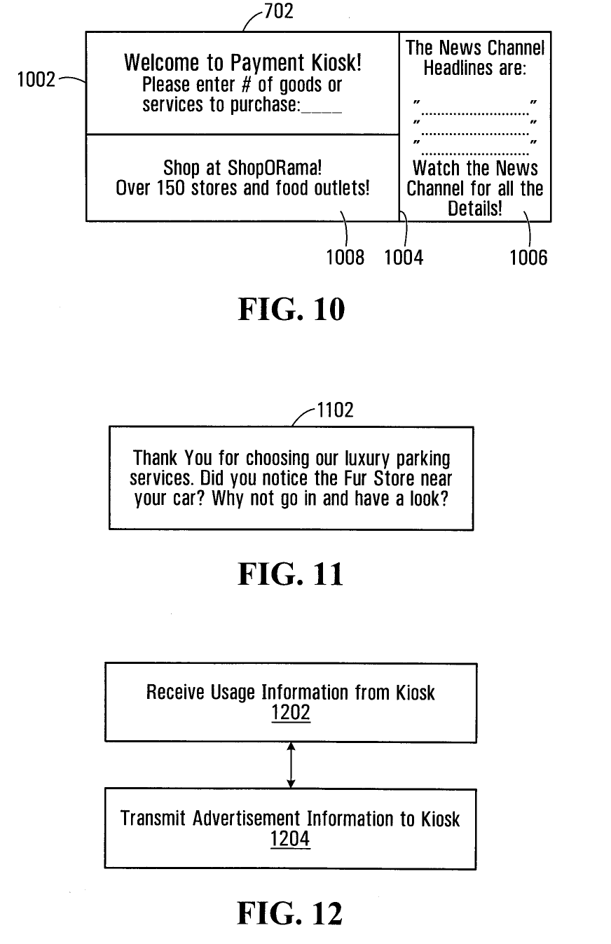

FIG. 10 illustrates the contents of display 702 in accordance with a non-limiting embodiment of the present invention. Display 702 is divided into multiple windows. Window 1002 displays information related to a good or service to be displayed while window 1004 displays advertising information and useful information. Window 1004 is further divided into two windows 1008 and 1006. In the illustrated embodiment, window 1008 displays advertisement content promoting a shopping center. Window 1006 displays news content in conjunction with advertisement content promoting a news channel. Although information related to goods or services is illustrated here in a separate window from advertisement content, it is to be appreciated that any of information related to a good or service, advertisement information and useful information may be displayed in the same window. Furthermore, although windows 1002, 1008 and 1006 are shown here as being separate, it is to be understood that windows may partially or wholly overlapping. The term window as used herein designates any user-viewable area presenting content to the user. It will be appreciated that advertisement content, does not need to be displayed simultaneously with information related to a good or service to be purchased. In a non-limiting embodiment, a user is intermittently exposed to full-screen windows presenting advertisement content before, during and/or after the purchasing of a good or service at payment kiosk 700.

FIG. 11 illustrates another non-limiting embodiment of the contents displayed on display 702 in accordance with the present invention. In this embodiment, a user is presented with advertisement content alongside information related to a good or service purchased. Here, it has been determined that the customer has purchased a luxury service and on the basis of this condition and, perhaps, on the type of credit card that was used in the payment, an advertisement has been selected for display. Here, advertisement content was displayed with information related to good or service purchased so as to increase user interest in the advertisement content.

The overall, general steps involved in the normal course of operation of the centralized control entity 902 are illustrated in FIG. 12. At step 1202, centralized control entity 902 receives usage information from the kiosk. In a non-limiting embodiment, centralized control entity compiles or stores this information internally. Usage information, as defined herein, is any information related to the usage of a payment kiosk 700 including information on a specific instance of use of the kiosk or information on past/historical use of the kiosk. In a non-limiting example, payment kiosk 700 transmits to central control entity 902 upon a completed purchase of a good or service at payment kiosk 700 information related to the purchase of the good or service. This information transmitted may include: user information received at user operable interface 706, payment information, information related to the good or service purchased, and advertisement information related to advertisements displayed on display 702. In another non-limiting embodiment, the payment kiosk 700 transmits usage information to control entity 902 upon the meeting of a condition such as: the expiration of a time limit since the last such transmission, reaching a certain number of purchases since the last transmission, reaching a certain time in a schedule, the occurrence of a certain event of interest, and the receipt of a request from control entity 902.

At step 1204 the control entity 902 transmits advertisement information to payment kiosk 700. As described above, this may or may not be in response to received usage information at the payment kiosk 700 or at any other payment kiosk. As described above, this may or may not be the same advertisement information sent to other payment kiosks 700.

Although step 1204 has been illustrated as succeeding step 1202, it is to be appreciated that both steps may be performed in any particular order, any number of time without departing from the spirit of the invention. In a non limiting example, centralized control entity 902 may receive usage information from a payment kiosk 700 at every purchase at payment kiosk 700 but only transmit advertisement information to the payment kiosk 700 when a change in the advertisement is proscribed.

In a non-limiting alternative embodiment, a payment unit 700 includes a printer for printing a user receipt. In a non-limiting embodiment, any type of advertisement information described above may be printed on a user receipt instead of, or in addition to, being displayed on a display 702. In this non-limiting embodiment, the user receipt includes information related to a sale of a good or service as well as advertisement information. The receipt may further include the useful information described above. The advertisement information can include a user-detachable coupon, which is detachable via perforations, or any other method known in the art. The coupon may be any promotional coupon and may represent a whole or partial value of a good or service. For example, the coupon may represent a discount on the price of a good or service (e.g. 10% off on a certain consumer good, such as a watch, or a free coffee, for example).

In a non-limiting embodiment, the user receipt can include information related to a sale of a good or service and may include any suitable information described above in the discussion pertaining to the contents displayed by display 702. In a non-limiting example, user receipt can include any of the following: transactional information, sale information, tracking information, information related to a good or a service purchased, instructions and any other information related to a sale of a good or service. In another non-limiting embodiment, the user receipt may include advertisement information which may include any suitable advertisement information described above in the present specification. In a non-limiting example, the advertisement information may include a coupon which may comprise a portion or all of the sender receipt.

Although various embodiments have been illustrated, this was for the purpose of describing, but not limiting, the invention. Various modifications will become apparent to those skilled in the art and are within the scope of this invention, which is defined more particularly by the attached claims.

1. A method for receiving a parcel to be shipped to a destination via at least one shipment provider, said method comprising:
a) receiving from a sender shipping information associated with the shipment of the parcel to be shipped, said shipping information including:
i) destination information;
ii) payment information;
b) receiving at a drop-off unit the parcel to be shipped from the sender;
c) associating the shipping information received from the sender with the received parcel;
d) generating at the drop-off unit a signal to be transmitted to the at least one shipment provider, said signal being indicative that at least one parcel has been received at the drop-off unit.

2. A method as defined in claim 1, wherein the signal is transmitted to the shipment provider over a wireless communication link.

3. A method as defined in claim 1, wherein the signal is generated at least in part on the basis of receipt at the drop-off unit of the parcel.

4. A method as defined in claim 1, wherein said payment information includes at least one of online banking information, shipment provider account information, credit card information, debit card information, pre-paid payment information, cellular phone payment information and RFID payment information.

5. A method as claimed in claim 1, wherein said payment information is provided at the drop-off unit.

6. A method as defined in claim 1, wherein the drop-off unit is connected to a network.

7. A method as defined in claim 1, further comprising providing transaction information to the sender following receipt of shipping information.

8. A drop-off unit for receiving a parcel to be shipped to a destination via at least one shipment provider, said drop-off unit comprising:
a) an interface suitable for receiving from the sender shipping information associated with the shipment of the parcel, said shipping information including:
i) destination information;
ii) payment information;
b) a receptacle suitable for receiving the parcel from a sender, the parcel being associated with the shipping information;
c) a processing unit suitable for generating a signal to be transmitted to the at least one shipment provider, said signal being indicative that at least one parcel has been received at the drop-off unit.

9. A drop-off unit as defined in claim 8, further comprising a transmitter for issuing the signal to the shipment provider over a wireless communication link. also describe one way communication and two way communication

10. A drop-off unit as defined in claim 8, wherein the processing unit generates the signal at least in part on the basis of receipt at the drop-off unit of the parcel.

11. A drop-off unit as defined in claim 8, wherein said interface is suitable for receiving payment information including at least one of online banking information, shipment provider account information, credit card information, debit card information, pre-paid payment information, cellular phone payment information and RFID payment information.

12. A drop-off unit as defined in claim 8, wherein said drop-off unit is connected to a network.

13. A drop-off unit as defined in claim 8, wherein said drop-off unit is operative for providing transaction information to the sender following receipt of shipping information.

14. A drop-off unit as defined in claim 8, wherein said drop-off unit includes printer capabilities.

15. A drop-off box for receiving a parcel to be shipped to a destination via at least one shipment provider, said drop-off unit comprising:
a) a user interface suitable for receiving from the sender destination information associated with the shipment of the parcel;
b) a cashless payment module comprising a debit/credit card reader for accepting as a payment mechanism a credit card or a debit card;
c) a processing unit suitable for communicating wirelessly with at least one shipment provider for validating the payment information received at the cashless payment module.

16. A method for receiving a parcel to be shipped to a destination via at least one shipment provider, said method comprising:
a) receiving from a sender shipping information associated with the shipment of the parcel to be shipped, said shipping information including:
i) destination information;
ii) payment information;
b) associating the shipping information received from the sender with a parcel to be received at a drop-off box;
c) generating a signal to be transmitted to the at least one shipment provider, said signal being indicative that at least one parcel has been received at the drop-off unit.

17. A payment kiosk for receiving from a user payment for a good or service, said payment kiosk comprising:
a) a common display screen operative for:
i) displaying to a user information about the good or service to be purchased;
ii) displaying advertisement information;
b) a user interface for enabling a user to enter payment information associated with a good or service to be purchased;
c) a processing unit for generating a signal indicative that a good or service has been purchased by the user on the basis of received payment information;
d) a transmitter suitable for transmitting said signal to a centralized control entity.

18. A payment kiosk as defined in claim 17, wherein said transmitter transmits said signal over a wireless communication link.

19. A payment kiosk as defined in claim 17, wherein said advertisement information is uploaded to said payment kiosk from said centralized control entity over a wireless communication link.

20. A payment kiosk as defined in claim 17, wherein said common display screen is further operative for displaying at least one of news information, weather information, map information, security information and lottery information.

21. A payment kiosk as defined in claim 17, wherein said processing unit is operative for:
a) recording activity information associated with said kiosk; and
b) causing a signal indicative of the activity information to be transmitted to the centralized control entity.

22. A method for managing information in a network of payment kiosks, each kiosk in the network of kiosks being operative for:
(1) displaying advertisement information;
(2) enabling a user to enter payment information associated with a good or service to be purchased;
said method comprising:
a) receiving at a centralized control entity a signal from at least one kiosk in the network of kiosks indicative of usage information;
b) transmitting from the centralized control entity to at least one payment kiosk advertisement information to be displayed at the at least one kiosk.

23. A method as defined in claim 22, wherein information exchanged between the network of payment kiosks and the centralized control entity is done over a wireless communication network.

24. A method as defined in claim 22, wherein said advertisement information is transmitted from said centralized control entity over a wireless communication link.

25. A method as defined in claim 22, further comprising transmitting from the centralized control entity to at least one payment kiosk information indicative of at least one of news information, weather information, map information, security information and lottery information, to be displayed at the kiosk.

26. A method as defined in claim 22, wherein said method further comprises:
c) recording activity information associated with said kiosk; and
d) causing a signal indicative of the activity information to be transmitted to the centralized control entity.
